(19) United States
(12) Patent Application Publication
(10) Pub. No.: US 2008/0302944 A1
(43) Pub. Date: Dec. 11, 2008

(54) Flexible support arm

(76) Inventor: Dana W. Freeman, Fort Collins, CO (US)

Correspondence Address: Michael A. Guth, 2-2905 East Cliff Drive, Santa Cruz, CA, 95062, US

(21) Appl. No.: 11/891,064

(22) Filed: Aug. 7, 2007

Related U.S. Application Data
(60) Provisional application No. 60/835,954, filed on Aug. 7, 2006.

(51) Int. Cl. F16M 13/00

(52) U.S. Cl. 248/558

(57) ABSTRACT

A flexible support arm adapted to position a device such as a camera or other device. The arm is of a flexible material rigid enough to support the weight of the device while maintaining a settable position. The arm may have a release attachment on one end for easy attachment and release of the device. The flexible support arm may have a light attached to its other end. The flexible support arm may be bent into a coil with a raised end in some uses, or may be wrapped around a pole or similar item in other uses.

### CROSS-REFERENCE TO RELATED APPLICATIONS

This application claims priority to U.S. Provisional Application No. 60/835,954, with a filing date of Aug. 7, 2006, to Freeman which is hereby incorporated by reference.

### BACKGROUND

1. Field of the Invention

This invention relates to support structures, and more specifically to a flexible support arm to be used with cameras and the like.

2. Description of Related Art

Typical support assemblies need to be hard mounted on one end in order to support an item, or have a base of some sort. What is called for is a support apparatus able to be mounted to a variety of features, such as poles, and vertical elements, with ease both of mounting and removal.

### SUMMARY

A flexible support arm adapted to position a device such as a camera or other device. The arm is of a flexible material rigid enough to support the weight of the device while maintaining a settable position. The arm may have a release attachment on one end for easy attachment and release of the device. The flexible support arm may have a light attached to its other end. The flexible support arm may be bent into a coil with a raised end in some uses, or may be wrapped around a pole or similar item in other uses.

### BRIEF DESCRIPTION OF THE DRAWINGS

FIG. 1 is a sketch of a flexible support arm supporting a camera according to some embodiments of the present invention.

FIG. 2 is sketch of a flexible support arm supporting a cellular telephone according to some embodiments of the present invention.

FIG. 3 is a sketch of a flexible support arm according to some embodiments of the present invention.

FIG. 4 is a sketch of a flexible support arm on a horizontal support according to some embodiments of the present invention.

### DETAILED DESCRIPTION

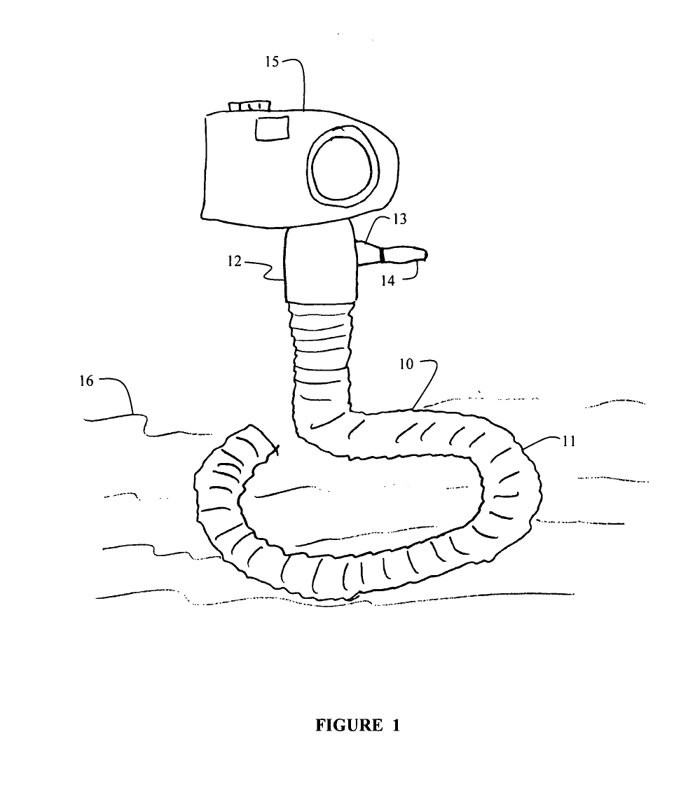

In some embodiments of the present invention, as seen in FIG. 1, a flexible support arm 10 is seen supporting a camera 15. The flexible support arm 10 is seen laying on a surface 16, which may be the ground, or a table top, for example. The arm portion 11 is adapted to be flexible enough such that the user may bend the arm portion into a desired position, but also rigid enough to support a device such as a camera 15. The flexible support arm is adapted to allow the user to create a coil by flexing the arm portion 11, and then to place the arm portion 11 on the ground, while positioning a camera 15 or other device. The arm portion 11 may be made of a flexible tube or other material. In some embodiments, the arm portion may be a bendable arm with a flexible tube around it.

In some embodiments, the flexible support arm 10 has an attachment portion 12 on a first end. The attachment portion 12 may contain a releasable attachment mechanism is some embodiments. The attachment portion 12 may have a release arm 13 with a release tab 14 which, when actuated, releases the camera 15 or other device from the attachment portion 12. The camera 15 may have a clip or attachment adapted to fit into the attachment portion 12 and be released. In some embodiments, the release device may be adapted to grab an extension of the clip, such as a pin. Upon bending of the release tab, the captured pin extension of the clip may release.

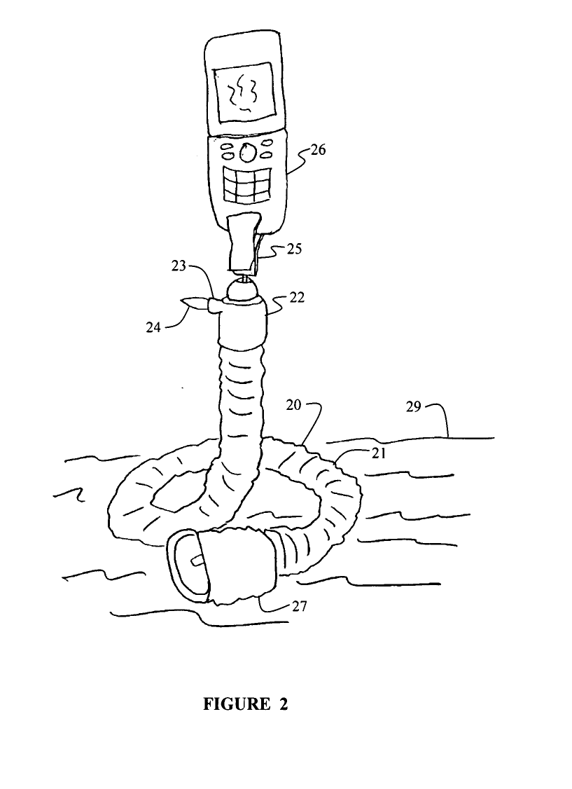

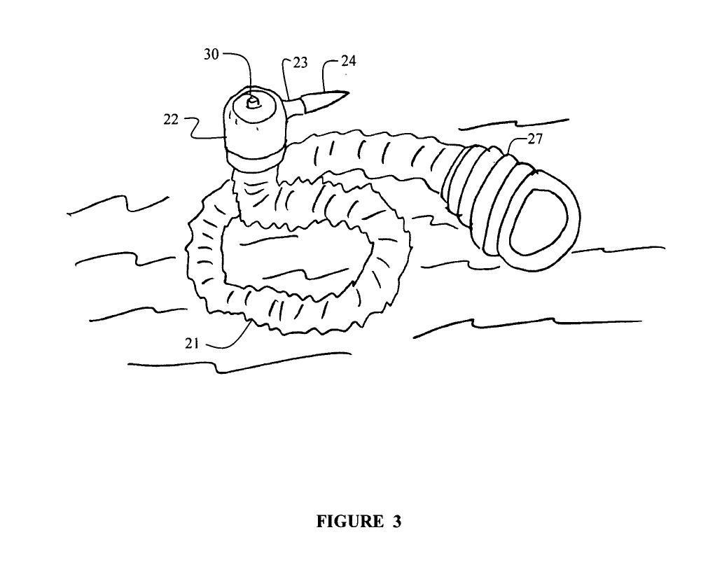

FIGS. 2 and 3 illustrate another embodiment of a flexible support arm 20 according to some embodiments of the present invention. As seen in FIG. 2, a flexible support arm 20 is seen supporting a camera 26. The flexible support arm 20 is seen laying on a surface 29, which may be the ground, or a table top, for example. The arm portion 21 is adapted to be flexible enough such that the user may bend the arm portion into a desired position, but also rigid enough to support a device such as a cellular telephone 26. The cellular telephone may be attached to the attachment portion 22 using a clip 25 or other means. The clip 25 may be similar to a clothes pin with a pin adapted to be releaseably captured and held by the attachment portion 22.

The flexible support arm is adapted to allow the user to create a coil by flexing the arm portion 21, and then to place the arm portion 21 on the ground, while positioning a device. The arm portion 21 may be made of a flexible tube or other material.

In some embodiments, the flexible support arm 20 has an attachment portion 22 on a first end. The attachment portion 22 may contain a releasable attachment mechanism is some embodiments. The attachment portion 22 may have a release arm 23 with a release tab 24 which, when actuated, releases the clip 25 or other device from the attachment portion 22. In some embodiments, the flexible support arm 20 has a light 27 at a second end. The light may be an LED flashlight in some embodiments.

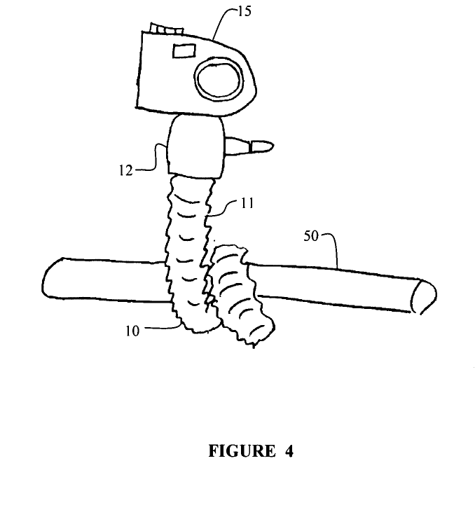

FIG. 4 illustrates another use of the flexible support arm 10 according to some embodiments of the present invention. The flexible support arm 10 is seen wrapped around a member.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

I claim:

1. A flexible support arm, said flexible support arm comprising:
an arm portion, said arm portion comprising:
a flexible tube;
a first end; and
a second end, said arm portion adapted to be bent into a plurality of positions; and
an attachment portion, said attachment portion attached to said first end of said arm portion, said attachment portion adapted to removably attach a mating piece.

2. The flexible support arm of claim 1 wherein said attachment portion comprises a release lever.

3. The flexible support arm of claim 1 further comprising a light attached to said second end of said arm portion.

4. The flexible support arm of claim 1 further comprising a clip, said clip removeably attached to said attachment portion.

5. The flexible support arm of claim 4 wherein said clip is a spring loaded clip.

6. The flexible support arm of claim 3 further comprising a clip, said clip removeably attached to said attachment portion.

7. The flexible support arm of claim 6 wherein said clip is a spring loaded clip.

8. A flexible support arm, said flexible support arm comprising:
a flexible arm, said flexible arm comprising:
a first end; and
a second end, said flexible arm adapted to be bent into a plurality of positions; and
an attachment portion, said attachment portion attached to said first end of said flexible arm, said attachment portion adapted to removably attach a mating piece.

9. The flexible support arm of claim 8 wherein said attachment portion comprises a release lever.

10. The flexible support arm of claim 8 further comprising a light attached to said second end of said flexible arm.

11. The flexible support arm of claim 8 further comprising a clip, said clip removeably attached to said attachment portion.

12. The flexible support arm of claim 11 wherein said clip is a spring loaded clip.

13. The flexible support arm of claim 10 further comprising a clip, said clip removeably attached to said attachment portion.

14. The flexible support arm of claim 13 wherein said clip is a spring loaded clip.
